(19) United States
(12) Patent Application Publication
(10) Pub. No.: US 2024/0426396 A1
(43) Pub. Date: Dec. 26, 2024

(54) PNEUMATIC VALVE ARRANGEMENT

(71) Applicant: Buerkert Werke GmbH & Co. KG, Ingelfingen (DE)

(72) Inventor: Uwe KRUG, Ingelfingen (DE)

(21) Appl. No.: 18/748,677

(22) Filed: Jun. 20, 2024

(30) Foreign Application Priority Data
Jun. 23, 2023 (DE) 102023116636.0

(51) Int. Cl. F16K 37/00

(52) U.S. Cl. CPC F16K 37/0091; F16K 37/0058; F16K 37/0083

(57) ABSTRACT

A pneumatic valve arrangement is specified, including a valve island having at least two solenoid valves, and at least two process valves, the process valves each including a working piston which delimits a pressure chamber, the solenoid valves being each set up to open or close a flow path from a pressure source to an associated process valve to apply a working medium on the pressure chamber of the associated process valve to open and/or close the process valve. Each process valve comprises a position measuring system which is set up to continuously detect an open position of the process valve. The valve island includes a control unit which is communicatively connected to the position measuring systems of the at least two process valves via one single digital communication interface arranged on the valve island.

### FIELD OF DISCLOSURE

The present disclosure relates to a pneumatic valve arrangement having a valve island. The valve island comprises at least two solenoid valves. Furthermore, the pneumatic valve arrangement comprises at least two process valves. The process valves are in particular driven by the solenoid valves in that a switching fluid is conveyed from the solenoid valves to the process valves.

### BACKGROUND

Generally, up to 32 process valves can be driven by means of a valve island. In known pneumatic valve arrangements, the individual process valves have sensors such as inductive proximity switches, mechanical contacts or capacitive proximity switches which are adapted to detect an upper and a lower position of the respective process valve, i.e. a fully open or a fully closed position of the process valve. The process valves are each connected to the valve island, in particular a control unit of the valve island, by two electronic lines. Signals are transmitted to the control unit via the electronic lines when a process valve has reached an upper or a lower switching position.

Electrical lines are additionally required for voltage supply and ground.

Such pneumatic valve arrangements therefore have a large number of lines, which results in a high setting-up effort. This also makes assembly and maintenance of the pneumatic valve arrangement more difficult.

It is therefore the object of the present disclosure to provide a pneumatic valve arrangement comprising a valve island and a plurality of process valves, in which the setting-up effort is reduced.

### SUMMARY

According to the disclosure, this object is achieved by a pneumatic valve arrangement comprising a valve island which comprises at least two solenoid valves, and at least two process valves, the process valves each comprising a working piston which delimits a pressure chamber, and the solenoid valves being each set up to open or close a flow path from a pressure source to an associated process valve to apply a working medium on the pressure chamber of the associated process valve to open and/or close the process valve. Each process valve comprises a position measuring system which is set up to continuously detect an open position of the process valve. The valve island comprises a control unit which is communicatively connected to the position measuring systems of the at least two process valves via one single digital communication interface arranged on the valve island.

The pneumatic valve arrangement according to example embodiments has the advantage that due to the fact that signal transmission from the valve island to the process valves takes place via a single communication interface, the setting-up effort and the complexity of the pneumatic valve arrangement are significantly reduced compared to known solutions.

In addition, in contrast to known solutions, communication between the valve island and the process valves is possible in both directions, which enables an extended functionality. For example, it is possible to implement various functions such as an auto-tune function and further control functions.

As the position measuring system is configured to continuously detect an open position of the process valve, it is possible to detect valve strokes and to draw conclusions about seal wear.

The communication interface is for example a bus interface, an IO-Link or a Single Pair Ethernet (SPE) interface.

Preferably, the process valves are pneumatic valves. The working medium is thus compressed air.

The valve island preferably comprises a carrier plate onto which the solenoid valves are arranged. This also contributes to a compact structure of the pneumatic valve arrangement.

According to one embodiment, the position measuring system is set up to detect the position of the working piston. The position of the working piston reflects the degree of opening of the process valve, so that the open position of the process valve can be reliably determined based on the position of the working piston.

Each process valve can comprise a monitoring unit in which the data measured by the position measuring system are recorded, the control unit of the valve island being communicatively connected to the monitoring unit via the digital communication interface. In this way, the communication connection between the control unit of the valve island and the position measuring system can be realized in a simple manner, for example via an appropriate communication interface on the process valve, which is connected to the monitoring unit.

For example, each process valve comprises a pressure sensor which is connected in a signaling manner to the monitoring unit. The data recorded by the position measuring system and by the pressure sensor can thus be combined in the monitoring unit and be transmitted to the control unit of the valve island. This contributes to a simple electronic structure of the pneumatic valve arrangement.

The pressure sensor in particular measures the pressure in the pressure chamber.

Further functions can be implemented in the pneumatic valve arrangement on the basis of the values measured by the pressure sensor.

For example, the control unit is set up to determine the pressure required to fully open the process valve based on the valve position detected by the position measuring system and the pressure detected by the pressure sensor. The compressed air consumption of the pneumatic valve arrangement can thus be reduced, in particular in that a supply of compressed air into the pressure chamber is stopped as soon as the pressure required to fully open the process valve is achieved, even if the working piston has not yet completely moved into the open position. Furthermore, it is possible to reduce the speed of the working piston towards an end position by appropriately controlling the compressed air supply, so that a soft-close function is possible.

Furthermore, the control unit can be set up to deduce a leakage based on the pressure measured in the pressure chamber, for example if the pressure does not increase accordingly when the working medium is supplied into the pressure chamber. Such a leakage may occur in the valve drive of the process valve or in the pneumatic lines between the valve island and the process valve. Such a leakage detection increases the process safety.

In addition, the control unit may calculate a consumption of the working medium based on the measured pressure.

Each process valve may comprise an optical signaling unit, and the monitoring unit may be set up to drive the optical signaling unit to visualize a valve state. For example, it is possible to visualize which process valve is connected to which solenoid valve both on the process valve and on the valve island. Furthermore, malfunctions can be visualized.

Starting from the communication interface of the valve island, one single main cable can run to the process valves, secondary cables branching off from the main cable to the process valves. This allows the process valves to be connected easily.

The secondary cables are for example electronically connected to the main cable by means of T-plugs. T-plugs make it particularly easy to implement branchings from the main cable. In addition, such plugs are available at low cost as a standard component.

### BRIEF DESCRIPTION OF DRAWINGS

Further advantages and features of the invention will become apparent from the description below and from the accompanying drawings, to which reference is made and in which:

FIG. 1 shows a pneumatic valve arrangement according to the invention, and

FIG. 2 shows a process valve.

### DETAILED DESCRIPTION

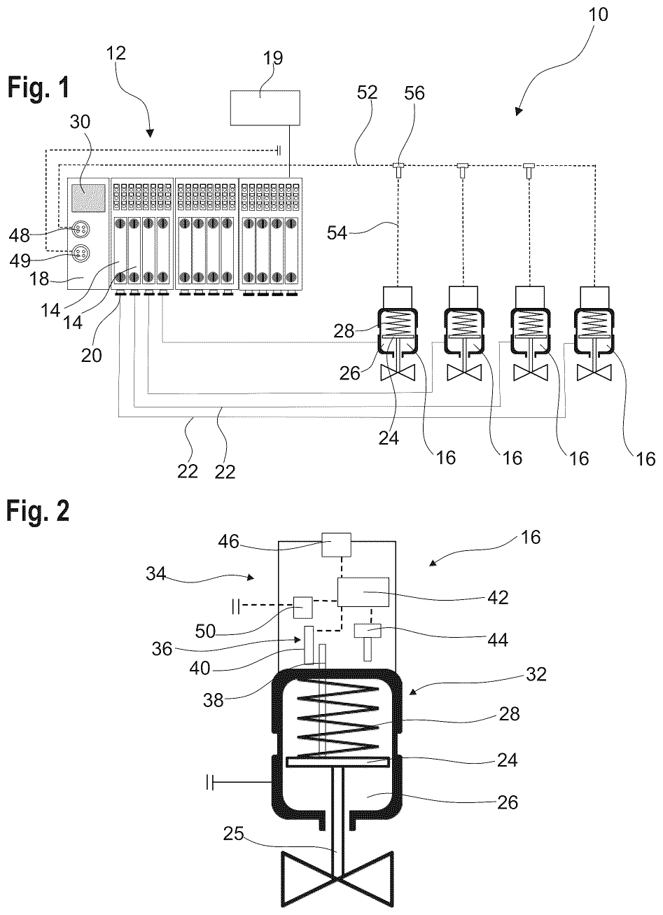

FIG. 1 shows a pneumatic valve arrangement 10 which includes a valve island 12 comprising a plurality of solenoid valves 14, and a plurality of process valves 16.

Usually, each solenoid valve 14 has one process valve 16 assigned thereto. However, only four process valves 16 are shown in FIG. 1 for the sake of clarity.

The solenoid valves 14 are arranged on a carrier 18. The carrier 18 is usually a fluid plate in which a plurality of fluid ducts are formed, which are however not illustrated in the figures for the sake of simplicity.

The fluid ducts extend from a pressure source 19 via one respective solenoid valve 14 to a fluid connection 20 so that a working medium can be provided at the fluid connection 20 depending of the switching position of the solenoid valve 14.

The process valves 16 are connected to the valve island 12, more specifically to the fluid connections 20 via fluid lines 22, so that the process valves 16 can be driven by the solenoid valves 14.

As also shown in FIG. 2, each process valve 16 comprises a working piston 24 which delimits a pressure chamber 26.

The working piston 24 is connected to a valve closing element 25 which rests against a valve seat in the closed state of the process valve 16.

A spring 28 which urges the piston into a normally closed position is arranged on a side of the working piston 24 which faces away from the pressure chamber 26. In an alternative embodiment, the spring 28 can be arranged such that the working piston 24 is urged into a normally open position.

The solenoid valves 14 are each set up so as to open or close a flow path from the pressure source 19 to an associated process valve 16, to apply a working medium onto the pressure chamber 26 of the associated process valve 16 to open the process valve 16 or, in the case of a normally open process valve 16, to close the process valve 16.

Furthermore, the valve island 12 comprises a control unit 30 which is set up to drive the solenoid valves 14 to control the supply of working medium to the pressure chamber 26.

The process valves 16 each comprise a driving unit 32 and an electronics chamber 34 fitted onto the driving unit 32. The driving unit 32 comprises the working piston 24 and the spring 28, whereas various electronic components of the process valve 16 are accommodated in the electronics chamber 34, as illustrated in FIG. 2.

Each process valve 16 comprises a position measuring system 36 (see FIG. 2), which is set up to continuously detect an open position of the process valve 16 to determine a valve position of the respective process valve 16.

More specifically, the position measuring system 36 is set up to detect the position of the working piston 24.

As illustrated in FIG. 2, this can be done via a tappet 38 which is fastened to the working piston 24 and projects into the electronics chamber 34 of the process valve 16.

The position measuring system 36 comprises, for example, a sensor 40, in particular a Hall sensor.

In an alternative example embodiment, the sensor 40 can be accommodated in the driving unit 32 of the process valve 16 and directly detect the position of the working piston 24.

Each process valve 16 also comprises a monitoring unit 42 which is also accommodated in the electronics chamber 34 of the process valve 16.

The data measured by the position measuring system 36 are recorded in the monitoring unit 42.

Each process valve also comprises a pressure sensor 44 which is set up to measure a pressure in the pressure chamber 26.

The pressure sensor 44 is also connected in a signaling manner to the monitoring unit 42.

The measured values of the position measuring system 36 and of the pressure sensor 44 are therefore combined in the monitoring system 42.

Furthermore, an optical signaling unit 46 which is visible from the outside on the process valve 16 is arranged in the electronics chamber 34.

The monitoring unit 42 is set up to drive the optical signaling unit 46 to visualize a valve state.

The signaling unit 46 preferably comprises an LED.

The control unit 30 is communicatively connected to the position measuring systems 36 of the process valves 16 via a single digital communication interface 48 arranged on the valve island 12 (see FIG. 1).

The valve island 12 can be connected to a central control means via a further communication interface 49.

The process valve 16 has an appropriate communication interface 50.

Starting from the communication interface 48 of the valve island 12, one single main cable 52 runs to the process valves 16, secondary cables 54 branching off from the main cable 52 to the process valves 16.

The main cable 52 is connected to the communication interface 48 of the valve island 12 via a standard plug. Similarly, the secondary cables 54 are connected to the communication interfaces 50 of the process valves 16 via standard plugs.

The secondary cables 54 are electronically connected to the main cable 52 by means of T-plugs 56.

The main cable 52 is in particular a communication cable via which information can be exchanged in both directions between the process valves 16 and the valve island 12.

The communication interface 50 of the process valve 16 is connected to the monitoring unit 42. This means that all information exchanged between the process valve 16 and the control unit 30 is exchanged via the monitoring unit 42.

It is thus possible to implement various functions in the pneumatic valve arrangement 10.

For example, the control unit 30 can be set up to determine the pressure required to fully open the process valve 16 based on the valve position detected by the position measuring system 36 and the pressure detected by the pressure sensor 44.

Furthermore, the control unit 30 can be set up to deduce a leakage based on the pressure measured in the pressure chamber 26.

In addition, the control unit 30 can deduce a seal wear and wear of the drive or of a stuffing box based on an end position detected by the position measuring system 36.

Furthermore, the control unit 30 can transmit information to the monitoring unit 42 which can be visualized on the signaling unit 46.

It is for example conceivable that the monitoring unit 42 drives the signaling unit 46 such that the signaling unit 46 flashes when the control unit 30 has detected a fault, for example a leakage.

In addition, wear of the process valve 16 can be signaled by means of the signaling unit 46.

Furthermore, the control unit 30 can determine a running time of the working piston 24 based on the values detected by the position measuring system 36, i.e. the time required by the working piston to move from an end position into the opposite end position.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A pneumatic valve arrangement comprising:
a valve island having at least two solenoid valves, and at least two process valves, the process valves each including a working piston which delimits a pressure chamber, the solenoid valves being each set up to open or close a flow path from a pressure source to an associated process valve to apply a working medium on the pressure chamber of the associated process valve to open and/or close the process valve,
each process valve including a position measuring system which is set up to continuously detect an open position of the process valve, and
the valve island including a control unit which is communicatively connected to the position measuring systems of the at least two process valves via one single digital communication interface arranged on the valve island.

2. The pneumatic valve arrangement-according to claim 1, wherein the position measuring system is set up to detect the position of the working piston.

3. The pneumatic valve arrangement according to claim 1, wherein each process valve comprises a monitoring unit in which the data measured by the position measuring system are recorded, the control unit of the valve island being communicatively connected to the monitoring unit via the digital communication interface.

4. The pneumatic valve arrangement-according to claim 3, wherein each process valve comprises a pressure sensor which is connected in a signaling manner to the monitoring unit.

5. The pneumatic valve arrangement according to claim 4, wherein the control unit is set up to determine the pressure required to fully open the process valve based on the valve position detected by the position measuring system and the pressure detected by the pressure sensor.

6. The pneumatic valve arrangement-according to claim 4, wherein the control unit is set up to deduce a leakage based on the pressure measured in the pressure chamber.

7. The pneumatic valve arrangement according to claim 3, wherein each process valve comprises an optical signaling unit and in that the monitoring unit is set up to drive the optical signaling unit to visualize a valve state.

8. The pneumatic valve arrangement-according to claim 1, wherein starting from the communication interface of the valve island, one single main cable runs to the process valves, secondary cables branching off from the main cable to the process valves.

9. The pneumatic valve arrangement-according to claim 8, wherein the secondary cables are electronically connected to the main cable by means of T-plugs.
